(19) United States
(12) Patent Application Publication
(10) Pub. No.: US 2021/0220947 A1
(43) Pub. Date: Jul. 22, 2021

(54) LASER WELDED SHEETS, LASER WELDING METHODOLOGY, AND HERMETICALLY SEALED DEVICES INCORPORATING THE SAME

(71) Applicant: CORNING INCORPORATED, CORNING, NY (US)

(72) Inventors: Michael Edward Badding, Campbell, NY (US); Leonard Charles Dabich, II, Painted Post, NY (US); David Mark Lance, Elmira, NY (US); Stephan Lvovich Logunov, Corning, NY (US); Mark Alejandro Quesada, Horseheads, NY (US); Alexander Mikhailovich Streltsov, Corning, NY (US)

(21) Appl. No.: 16/967,568

(22) PCT Filed: Feb. 19, 2019
(86) PCT No.: PCT/US2019/018518

§ 371 Date: Aug. 5, 2020

Related U.S. Application Data
(60) Provisional application No. 62/649,322, filed on Mar. 28, 2018.
(60) Provisional application No. 62/632,200, filed on Feb. 19, 2018.

(51) Int. Cl. B23K 26/211; B23K 26/57

(52) U.S. Cl. CPC B23K 26/211; B23K 2103/18; B23K 26/57

(57) ABSTRACT

A laser-welded assembly of opposing sheets of ceramic and glass, ceramic, or glass-ceramic compositions comprises an intervening bonding layer having a thickness dimension that separates the opposing sheets by less than about 1000 nm. Each of the opposing sheets has a thickness dimension at least about 20 times the thickness dimension of the intervening bonding layer. The intervening bonding layer has a melting point greater than that of one or both of the opposing sheets. The ceramic sheet is a pass-through sheet with a composite T/R spectrum comprising a portion that lies below about 30% across a target irradiation band residing at or above about 1400 nm and at or below about 4500 nm wavelength. The intervening bonding layer has an absorption spectrum comprising a portion that lies above about 80% across the target irradiation band. The assembly comprises a weld bonding the opposing surfaces of the opposing sheets.

### CROSS-REFERENCE TO RELATED APPLICATION

This application claims the benefit of priority of U.S. Provisional Application Ser. No. 62/632,200 filed on Feb. 19, 2018 and U.S. Provisional Application Ser. No. 62/649,322 filed on Mar. 28, 2018 the contents of which are relied upon and incorporated herein by reference.

### BACKGROUND

The present disclosure relates to technology for bonding relatively thin glass, ceramic, or glass-ceramic sheets, and to hermetically sealed devices fabricated from such bonded sheets. For example, US 2017/0047542 relates generally to methods for welding high thermal expansion substrates and, more particularly, to methods for hermetically sealing glass and glass-ceramic substrates having a high coefficient of thermal expansion using laser welding. U.S. Pat. No. 9,515,286 is generally directed to hermetic barrier layers and, more particularly, to methods and compositions used to seal solid structures using absorbing thin films and a laser welding or sealing process using a thin film with absorptive properties during the sealing process as an interfacial initiator. The aforementioned patent references are noted herein to help illustrate the context of some aspects of the present disclosure but should not be used to characterize the scope of the present application or to define any of the particular terms that are used in the present description or claims.

### BRIEF SUMMARY

The present inventors have recognized several challenges associated with the use of laser welding in the formation of a hermetically sealed device from opposing glass, ceramic, or glass-ceramic sheets. Specifically, some sheet materials, although partially transparent, scatter and absorb so much laser light that it is difficult to generate sufficient localized heating at the interface between the sheets to generate a weld. Additionally, the present inventors have noted that residual stresses at a laser-bonded interface between the sheet materials, particularly high-CTE ceramic sheets, may reach unacceptable levels, which can lead to crack formation in the sheets. These residual stresses can be particularly problematic in the context of thin sheets, i.e., sheets less than about 100 μm thick, or when bonding sheets with high CTE mismatch, e.g. high-CTE ceramic and low-CTE glass substrates. The present inventors have investigated laser welding at elevated temperatures to help alleviate these residual stresses but this approach can be costly and technically inconvenient when compared to laser welding at room temperature. Finally, the present inventors have recognized that ceramic sheets are particularly difficult to use to form hermetically sealed devices because ceramic materials typically have relatively rough surface features, creating interfacial gaps that present sealing challenges.

According to the subject matter of the present disclosure, the aforementioned challenges are at least partially addressed by optimizing particular laser-welding conditions to bring residual stresses to a minimum, achieve the necessary bond strength, and improve reliability of hermetically sealed laser-welded package.

In accordance with one embodiment of the present disclosure, a method of laser welding opposing sheets of glass, ceramic, or glass-ceramic compositions at a target irradiation band residing at or above about 1000 nm and at or below about 4500 nm is provided. According to the method, the opposing sheets are provided with an intervening bonding layer in contact with opposing surfaces of the opposing sheets. The intervening bonding layer comprises a thickness dimension that separates the opposing sheets by less than about 1000 nm. Each of the opposing sheets comprises a thickness dimension that is at least about 20 times greater than the thickness dimension of the intervening bonding layer. The intervening bonding layer is characterized by a melting point that is greater than a melting point of one or both of the opposing sheets, or is characterized by a melting point that is greater than about 1200° C. or, in some embodiments, greater than about 1500° C. At least one of the opposing sheets comprises a pass-through sheet that is characterized by a composite T/R spectrum comprising a portion that lies below about 30% across the target irradiation band. The intervening bonding layer is characterized by an absorption spectrum comprising a portion that lies above about 50-80% across the target irradiation band. However, it is noted that suitable absorption characteristics in the intervening bonding layer will depend upon the laser power and exposure time.

A weld line is created by bonding the opposing surfaces of the opposing sheets by directing a laser beam in the target irradiation band through the pass through sheet to the intervening bonding layer, wherein the laser beam is characterized by a power density in the intervening bonding layer and a translation speed along the intervening bonding layer that are selected to contain peripheral heating at or below about 100° C. beyond about 0.5 mm from the weld line, which minimizes thermal stresses, cracking, ablation, delamination, defects, bubbles, etc.

In accordance with another embodiment of the present disclosure, a method of laser welding opposing sheets of glass, ceramic, or glass-ceramic compositions at a target irradiation band residing at or above about 1000 nm and at or below about 4500 nm is provided. According to the method, the opposing sheets are provided with an intervening bonding layer in contact with opposing surfaces of the opposing sheets. The intervening bonding layer comprises a thickness dimension that separates the opposing sheets by less than about 1000 nm. Each of the opposing sheets comprises a thickness dimension that is at least about 10 times greater than the thickness dimension of the intervening bonding layer. The intervening bonding layer is characterized by a melting point that is lower than a melting point of one or both of the opposing sheets, and is characterized by a melting point that is lesser than the opposing sheet melting point by at least about 50° C. Furthermore, there is a significant elemental migration of the bonding layer material into the opposing sheets. At least one of the opposing sheets comprises a pass-through sheet that is characterized by losses below about 50% across the target irradiation band, while light absorption is small in the translucent pass-through opposing sheet. The intervening bonding layer is characterized by absorption above about 50% across the target irradiation band. A weld line is created by bonding the opposing surfaces of the opposing sheets by directing a laser beam in the target irradiation band through the scattering pass through sheet to the intervening bonding layer, wherein the laser beam is characterized by a power in the intervening bonding layer and a translation speed along the intervening bonding layer that are selected to contain peripheral heating at or below about 100° C. beyond about 0.5 mm from the weld line.

In one embodiment, at least one of the opposing sheets comprises a pass-through sheet that is characterized by losses below about 30% across a target irradiation band residing at or above about 1000 nm and at or below about 4500 nm.

In accordance with another embodiment of the present disclosure, a laser-welded assembly of opposing sheets of glass, ceramic, or glass-ceramic compositions is provided. The assembly comprises an intervening bonding layer in contact with opposing surfaces of the opposing sheets. The intervening bonding layer comprises a thickness dimension that separates the opposing sheets by less than about 1000 nm (in some cases less than about 1500 nm). Each of the opposing sheets comprises a thickness dimension that is at least about 10 to 20 times greater than the thickness dimension of the intervening bonding layer. The intervening bonding layer is characterized by a melting point that is greater than a melting point of one or both of the opposing sheets. At least one of the opposing sheets comprises a pass-through sheet that is characterized by a composite T/R spectrum comprising a portion that lies below about 30% across a target irradiation band residing at or above about 1400 nm and at or below about 4500 nm. The intervening bonding layer is characterized by an absorption spectrum comprising a portion that lies above about 80% across the target irradiation band. The assembly comprises a weld line bonding the opposing surfaces of the opposing sheets.

In accordance with yet another embodiment of the present disclosure, the target irradiation band may fall at shorter or longer wavelengths, e.g., in the vicinity of 355 nm, if a spacer layer that absorbs a significant portion of the irradiating laser beam is provided adjacent to the intervening bonding layer. For example, a ZnO spacer layer can be used with laser irradiation in the vicinity of 355 nm, as it can be tailored to be about 80% absorbent.

In accordance with yet another embodiment of the present disclosure, the properties of the pass-through sheet and the intervening bonding layer are tailored such that about 20% of the laser irradiation is absorbed in the pass-through sheet and about 80% of the laser irradiation is absorbed in the intervening bonding layer.

Although the concepts of the present disclosure are described herein with primary reference to opposing sheets of relatively generic and uniform structure and composition, it is contemplated that the concepts will enjoy applicability in a variety of more complex scenarios. For example, where the opposing sheets include additional structural features or complementary components.

### BRIEF DESCRIPTION OF THE SEVERAL VIEWS OF THE DRAWINGS

The following detailed description of specific embodiments of the present disclosure can be best understood when read in conjunction with the following drawings, where like structure is indicated with like reference numerals and in which:

FIG. 1 is a schematic illustration of a method of laser welding opposing sheets of glass, ceramic, or glass-ceramic compositions;

FIG. 2 illustrates a composite T/R spectrum of one or more of the opposing sheets involved in the method illustrated in FIG. 1;

FIGS. 3 and 4 illustrate alternative methodology and opposing sheet structures where additional intervening bonding layers are provided between opposing sheets of a unitary sandwich structure; and

FIG. 5 illustrates a plurality of electrical, optical, or electrooptical devices provided between opposing sheets, including respective weld lines surrounding the devices between the opposing sheets.

### DETAILED DESCRIPTION

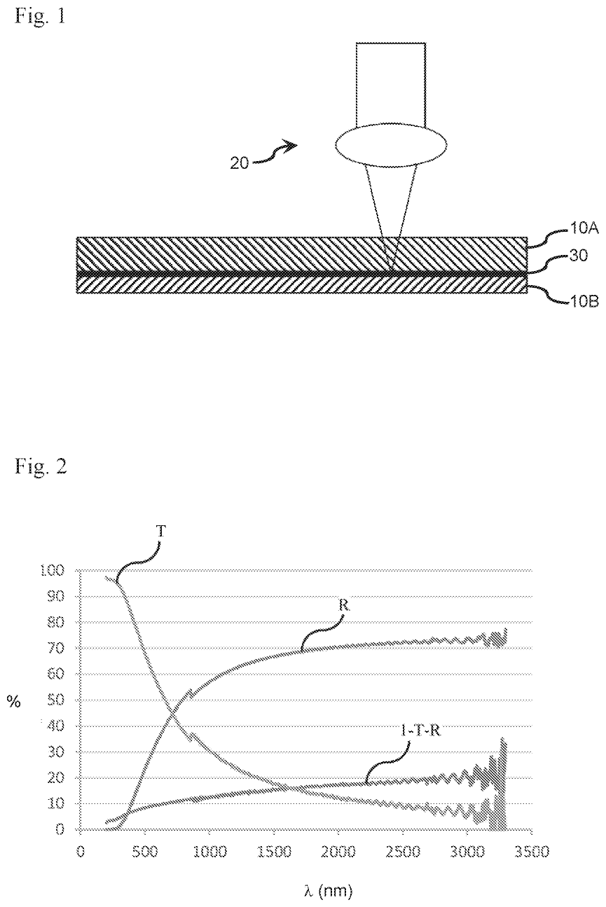

FIG. 1 illustrates a method of laser welding opposing sheets 10A, 10B of glass, ceramic, or glass-ceramic compositions. FIG. 1 includes a schematic illustration of a laser assembly 20 that is configured for laser welding at a target irradiation band, which band may reside somewhere at or above about 1400 nm and at or below about 4500 nm. According to the method, the opposing sheets 10A, 10B are assembled with an intervening bonding layer 30 that is in contact with opposing surfaces of the opposing sheets 10A, 10B and a weld line is created in the assembly to bond the opposing surfaces of the opposing sheets 10A, 10B by directing a laser beam in the target irradiation band through one of the opposing sheets 10A, 10B to the intervening bonding layer 30. The opposing sheets 10A, 10B may be assembled with the intervening bonding layer 30 by pressing the opposing sheets 10A, 10B and the intervening bonding layer 30 between two fused silica blocks. The opposing sheets 10A, 10B may also be referred to herein as a first sheet 10A and a second sheet 10B.

The intervening bonding layer 30 separates the opposing sheets 10A, 10B by less than about 1000 nm. This separation is attributable to the thickness dimension of the intervening bonding layer 30. In contrast, each of the opposing sheets 10A, 10B comprise a thickness dimension that is at least about 20 times greater than the thickness dimension of the intervening bonding layer 30. The intervening bonding layer 30 also has a relatively high melting point. More specifically, the intervening bonding layer 30 is characterized by a melting point that is greater than the melting point of one or both of the opposing sheets 10A, 10B (about 1670° C. for a Ti intervening boding layer 30).

One or both of the opposing sheets 10A, 10B can be the “pass-through” sheet, that is, the sheet through which the aforementioned laser beam is directed. FIG. 2 illustrates a composite T/R spectrum of one of the many types of pass-through sheets that may be employed in a laser welded assembly of the present disclosure. As is illustrated in FIG. 2, the composite T/R spectrum is a composite of the transmissive (T) and reflective (R) properties of the pass-through sheet, as a function of wavelength (λ) and, more particularly, can be defined by the relation Absorption=1−T−R. The pass-through sheet is characterized by a composite T/R spectrum that comprises a portion that lies below about 30% across the target irradiation band. For example, and not by way of limitation, given a 1550 nm near-IR fiber laser with a spectral bandwidth of about 5 nm, the 10 nm band of the composite T/R spectrum centered about 1550 nm lies slightly below 20%. Several other 10 nm bands of the composite T/R spectrum illustrated in FIG. 2 also lie well below 30%; most clearly, those that fall between about 1000 nm and about 3250 nm. This range will vary depending on the properties of the particular sheets in use, and the absorptive properties of the intervening bonding layer 30. In some embodiments, for example, the target irradiation band will resides at or above about 1400 nm and at or below about 3000 nm and each of the opposing sheets 10A, 10B will be characterized by a composite T/R spectrum comprising a portion that lies below about 20% across the target irradiation band.

In contrast, the intervening bonding layer 30 is much more absorptive of radiation in the target irradiation band. More specifically, it is characterized by an absorption spectrum that comprises a portion above about 80% across the target irradiation band. As a result, referring to FIG. 1, a weld line bonding the opposing surfaces of the opposing sheets 10A, 10B can be created by directing a laser beam from a laser assembly 10 in the target irradiation band through the pass through sheet (sheet 10A in FIG. 1) to the intervening bonding layer 30. This may be accomplished at room temperature, without the use of supplemental heating. Suitable compositions for the intervening boding layer 30, which may be electrically conductive, or non-conductive, include Ti, a Ti metal alloy, TiO₂, SnO₂, Fe₂O₃, NiO, Cr₂O₃, or combinations thereof. Suitable laser sources may be selected from a variety of conventional laser sources, like a single mode fiber laser, or from yet-to-be developed laser sources.

In some embodiments, the thickness dimension of each of the opposing sheets 10A, 10B is about 200 μm, or less, and the thickness dimension of the intervening bonding layer 30 is about 1 μm, or less. In other embodiments, the intervening bonding layer 30 and/or the opposing sheets 10A, 10B may be thinner, e.g., about 200 nm, or less, for the intervening bonding layer 30, and about 100 μm, or less, for the opposing sheets 10A, 10B. In one particular embodiment, the opposing sheet through which the laser beam is directed, i.e., the pass-through sheet, comprises an approximately 40 μm thick translucent 3-mol % yttria-stabilized zirconia (3YSZ) ceramic sheet, and the sheet on an opposite side of the intervening bonding layer 30 comprises an approximately 700 μm glass substrate, e.g., a borosilicate glass such as Eagle XG® glass.

In many cases, the propagation loss of the pass through sheet, which is a function of the transmissive (T) and reflective (R) properties of the pass-through sheet, may fall between about 0.1 dB/m and about 10 dB/m in the target irradiation band without disrupting creation of the aforementioned weld line. The pass through sheet may also be characterized in terms of its scattering loss in the target irradiation band—which may be less than about 30%. This characteristic of the pass-through sheet may also be represented in terms of scattering loss, which may be about 30%, or less. For example, and not by way of limitation, the pass-through sheet may comprise a yttria-stabilized zirconia (YSZ) ceramic sheet. In many embodiments, one of the opposing sheets 10A, 10B comprises a glass sheet and the other opposing sheet, which may be the pass-through sheet, comprises a ceramic or glass-ceramic sheet. For example, the first sheet 10A may comprise a ceramic or glass-ceramic sheet and the second sheet 10B may comprise a glass sheet. In many cases, the pass-through sheet may comprise a larger scattering loss than the opposing sheet on the opposite side of the intervening bonding layer 30. Other examples of suitable pass-through sheets compositions include alumina, magnesium aluminate spinel (MgAl₂O₄), silica, mullite, cordierite, aluminum nitride, silicon carbide, AlON, or combinations thereof. To achieve the necessary transmissive properties, it is preferred that the pass through ceramic sheet is near full density to reduce optical scattering. Furthermore it is preferred the pass through ceramic sheet should be sufficiently thin to reduce scattering. Pass through ceramic sheets less than about 200-500 um thick are preferred. Such dense, thin ceramic sheets may appear optically translucent compared to conventional ceramic sheets which are typically thick and opaque.

The power of the laser beam in the intervening bonding layer 30 and the translation speed of the laser beam along the intervening bonding layer 30 are selected and controlled to contain peripheral heating at or below about 100° C. beyond about 0.5 mm from the weld line to limit the exposure of any electrical, optical, or electrooptical components between the opposing sheets 10A, 10B and to optimize the precision of the weld line. More specifically, in one embodiment, the laser beam is directed with a power of between about 3 W and about 4 W, and a translation speed of about 300 mm/s. In many cases, it will be appropriate to utilize relatively low laser powers and low translation speeds, or relatively high laser powers with relatively high translation speeds. More specifically, in some embodiments it will be appropriate to utilize a laser beam that approximates conditions (a) or (b) more closely than it approximates condition (c), where:
(a) corresponds to a laser power of about 0.95 W and a translation speed of about 30 mm/s;
(b) corresponds to a laser power of about 3 W and a translation speed of about 300 mm/s; and
(c) corresponds to a laser power of about 1.8 W and a translation speed of about 30 mm/s.

In many cases, particularly in the case of a Ti intervening bonding layer having a thickness dimension of between about 0.05 μm and about 1.5 μm, it will be appropriate to ensure that the power in the intervening boding layer 30 is between about 1 W and about 5 W for translation speeds of about 300 mm/s, between about 0.5 W and about 1.5 W for translation speeds of about 30 mm/s, or between about 0.7 W and about 3 W for translation speeds of about 150 mm/s. Similar power densities and translation speeds can be extrapolated for bonding layer materials of similar thicknesses and melting points. Generally, translation speeds should increase with increasing power according to, for example, a linear relation, e.g., 50 mm/sec at 3 W power, 85 mm/sec at 5 W power, etc. Spot size may be estimated as 100 μm×100 μm, which translates to a minimum power density of about 3×10⁸ W/m².

In many cases, it will be appropriate to control the spot size of the laser beam in the intervening bonding layer 30 to contain peripheral heating or to maintain weld line precision while creating the aforementioned weld line. For example, in particular embodiments, the weld line is created by controlling the beam spot size of the directed laser beam in the intervening bonding layer 30 to be between about 5 μm and about 100 μm. In many cases, weld line precision and performance can also be enhanced by ensuring that the weld line is created at least 100 μm inside of a periphery of the opposing faces of the opposing sheets 10A, 10B.

Aspects of the presently disclosed technology have particular utility where the opposing sheets 10A, 10B comprise respective coefficients of thermal expansion (CTE) that differ by at least 3 ppm/° C. For example, this would be the case where a ceramic sheet is to be bonded with a glass sheet, as many ceramic sheet materials are characterized by a CTE of between about 9 ppm/° C. and about 13 ppm/° C. and may glass sheet materials are characterized by a CTE of about 3.5 ppm/° C. For these types of disparate CTE sheets, the thickness dimension of the intervening bonding layer 30 is low enough to ensure that residual stress created by the difference between the respective CTEs of the opposing sheets 10A, 10B is below the ceramic sheet strength.

The intervening bonding layer 30 may comprises a patterned or continuous bonding layer. To enhance absorption of the welding laser beam, the intervening bonding layer 30 may be provided with a single or multi-layer absorption enhancement coating that has a higher absorption than the intervening boding layer across the target irradiation band. This absorption enhancement coating may, for example, comprise combination of reflective and anti-reflective coatings.

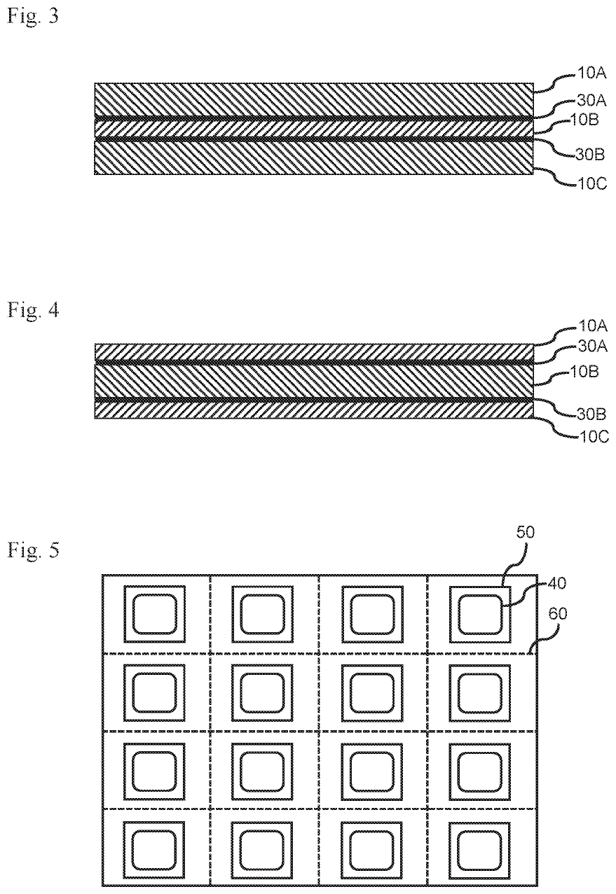

FIGS. 3 and 4 illustrate an embodiment of the present disclosure where a plurality of opposing sheets 10A, 10B, 10C are assembled with intervening bonding layers 30A, 30B in a unitary sandwich structure. In these embodiments, the unitary sandwich structure may comprise opposing sheets 10A, 10B, 10C of successively varying composition through the layers of the unitary sandwich structure.

FIG. 5 illustrates a plurality of electrical, optical, or electrooptical devices 40 provided between opposing sheets including respective weld lines 50 surrounding the devices between the opposing sheets to hermetically seal the devices 40 there between. These devices may be singulated by cutting through the resulting multilayer structure along cutting lines 60. Examples of devices that may be provided include, but are not limited to, flexible, rigid, or semi-rigid components of LED lighting, OLED lighting, LED/OLED televisions, photovoltaic devices, MEMs displays, electrochromic windows, fluorophore devices, alkali metal electrodes, transparent conducting oxide devices, quantum dot devices, etc.

It is also noted that recitations herein of “at least one” component, element, etc., should not be used to create an inference that the alternative use of the articles “a” or “an” should be limited to a single component, element, etc.

For the purposes of describing and defining the present invention it is noted that the term “about” is utilized herein to represent the inherent degree of uncertainty that may be attributed to any quantitative comparison, value, measurement, or other representation. The term “about” is also utilized herein to represent the degree by which a quantitative representation may vary from a stated reference without resulting in a change in the basic function of the subject matter at issue.

Having described the subject matter of the present disclosure in detail and by reference to specific embodiments thereof, it is noted that the various details disclosed herein should not be taken to imply that these details relate to elements that are essential components of the various embodiments described herein, even in cases where a particular element is illustrated in each of the drawings that accompany the present description. Further, it will be apparent that modifications and variations are possible without departing from the scope of the present disclosure, including, but not limited to, embodiments defined in the appended claims. More specifically, although some aspects of the present disclosure are identified herein as preferred or particularly advantageous, it is contemplated that the present disclosure is not necessarily limited to these aspects.

It is noted that one or more of the following claims utilize the term “wherein” as a transitional phrase. For the purposes of defining the present invention, it is noted that this term is introduced in the claims as an open-ended transitional phrase that is used to introduce a recitation of a series of characteristics of the structure and should be interpreted in like manner as the more commonly used open-ended preamble term “comprising.”

What is claimed is:

1. A method of laser welding a ceramic sheet and a second sheet at a target irradiation band residing at or above about 1000 nm wavelength, the method comprising:
assembling the ceramic sheet and the second sheet as opposing sheets with an intervening bonding layer in contact with opposing surfaces of the ceramic sheet and the second sheet, wherein the ceramic sheet comprises a ceramic; and
directing a laser beam in the target irradiation band through the ceramic sheet to the intervening bonding layer thereby weld line bonding the opposing surfaces of the ceramic sheet and the second sheet.

2. The method of claim 1, wherein the intervening bonding layer comprises a thickness dimension that separates the ceramic sheet and the second sheet by less than about 1000 nm.

3. The method of claim 1, wherein the intervening bonding layer is characterized by a melting point that is greater than a melting point of one or both of the ceramic sheet and the second sheet.

4-5. (canceled)

6. The method of claim 3, wherein the melting point of the intervening bonding layer is at least about 1200-1500° C. or is lower than the melting point of one of the ceramic sheet and the second sheet by at least about 50° C.

7. (canceled)

8. The method of claim 1, wherein each of the ceramic sheet and the second sheet comprise a thickness dimension that is at least about 20 times greater than the thickness dimension of the intervening bonding layer.

9. (canceled)

10. The method of claim 1 wherein the thickness dimension of each of the ceramic sheet and the second sheet is about 200 μm, or less, and the thickness dimension of the intervening bonding layer is about 1 μm, or less.

11. (canceled)

12. The method of claim 1 wherein the ceramic sheet comprises Yttria-stabilized zirconia (YSZ), and the second sheet comprises a glass substrate.

13-14. (canceled)

15. The method of claim 1 wherein the ceramic sheet comprises a larger scattering loss than the second sheet.

16. The method of claim 1 wherein the second sheet also comprises ceramic.

17. The method of claim 1 wherein the ceramic sheet and the second sheet comprise respective coefficients of thermal expansion (CTE) that differ by at least 3 ppm/° C.

18-20. (canceled)

21. The method of claim 1 wherein the laser beam is characterized by a laser power in the intervening bonding layer and a translation speed along the intervening bonding layer that are selected to contain peripheral heating at or below about 100° C. beyond about 0.5 mm from the weld line.

22-25. (canceled)

26. The method of claim 1 wherein the weld line is created at least 100 μm inside of a periphery of the ceramic sheet and the second sheet.

27. (canceled)

28. The method of claim 1, wherein:
the method comprising assembling a plurality of opposing sheets with intervening bonding layers in a unitary sandwich structure with additional intervening bonding layers therebetween; and
the unitary sandwich structure comprises opposing sheets of successively varying composition through layers of the unitary sandwich structure.

29. (canceled)

30. The method of claim 1 wherein the method further comprises:
providing an optical, electrical, or optoelectrical device between the ceramic sheet and the second sheet;
creating the weld line to surround the device between the ceramic sheet and the second sheet; and
the weld line hermetically seals the device between the ceramic sheet and the second sheet.

31-37. (canceled)

38. A method of laser welding opposing sheets of ceramic at a target irradiation band residing at or above about 1400 nm and at or below about 4500 nm wavelength, the method comprising:
assembling the opposing sheets with an intervening bonding layer in contact with opposing surfaces of the opposing sheets, wherein
the intervening bonding layer comprises a thickness dimension that separates the opposing sheets by less than about 1000 nm,
each of the opposing sheets comprise a thickness dimension that is at least about 20 times greater than the thickness dimension of the intervening bonding layer,
the intervening bonding layer is characterized by a melting point that is greater than about 1200° C.,
at least one of the opposing sheets comprises a pass-through sheet comprising a ceramic that is characterized by a composite T/R spectrum comprising a portion that lies below about 30% across the target irradiation band, and
the intervening bonding layer is characterized by an absorption spectrum comprising a portion that lies above about 80% across the target irradiation band; and
creating a weld line bonding the opposing surfaces of the opposing sheets by directing a laser beam in the target irradiation band through the pass-through sheet to the intervening bonding layer, wherein the laser beam is characterized by a power density in the intervening bonding layer and a translation speed along the intervening bonding layer that are selected to contain peripheral heating at or below about 100° C. beyond about 0.5 mm from the weld line.

39. A method of laser welding opposing sheets of ceramic at a target irradiation band residing at or above about 1000 nm and at or below about 4500 nm wavelength, the method comprising:
assembling the opposing sheets with an intervening bonding layer in contact with opposing surfaces of the opposing sheets, wherein
the intervening bonding layer comprises a thickness dimension that separates the opposing sheets by less than about 1500 nm,
each of the opposing sheets comprise a thickness dimension that is at least about 10 times greater than the thickness dimension of the intervening bonding layer,
the intervening bonding layer is characterized by a melting point that is lower than a melting point of one or both of the opposing sheets,
at least one of the opposing sheets comprises a pass-through sheet that is characterized by losses below about 50% across the target irradiation band, and
the intervening bonding layer is characterized by absorption above about 50% across the target irradiation band; and
creating at least one weld line bonding the opposing surfaces of the opposing sheets by directing a laser beam in the target irradiation band through the pass-through sheet to the intervening bonding layer, wherein the laser beam is characterized by power in the intervening bonding layer, a beam spot diameter, and a translation speed along the intervening bonding layer, wherein a resulting bond/seal is characterized by element migration in the fusion zone between the intervening bonding layer and the opposing sheets.

40. (canceled)

41. The method of claim 38, wherein the intervening bonding layer comprises a thickness dimension that separates the first sheet and the second sheet by less than about 1000 nm.

42. The method of claim 38, wherein the intervening bonding layer is characterized by a melting point that is greater than a melting point of one or both of the second sheet.

43. The method of claim 39, wherein the first ceramic sheet and the second sheet comprise respective coefficients of thermal expansion (CTE) that differ by at least 3 ppm/° C.

44. The method of claim 39, wherein the method further comprises:
providing an optical, electrical, or optoelectrical device between the first sheet and the second sheet;
creating the weld line to surround the device between the first sheet and the second sheet; and
the weld line hermetically seals the device between the first sheet and the second sheet.
